(19) United States
(12) Patent Application Publication
(10) Pub. No.: US 2007/0000830 A1
(43) Pub. Date: Jan. 4, 2007

(54) Replaceable filter element

(76) Inventors: Jason P. Snider, Olney, IL (US); John W. Stockhowe, Carmi, IL (US)

Correspondence Address: OLSON & HIERL, LTD., 20 NORTH WACKER DRIVE, 36TH FLOOR, CHICAGO, IL, 60606, US

(21) Appl. No.: 11/171,839

(22) Filed: Jun. 30, 2005

(51) Int. Cl. B01D 27/08; B01D 27/00

(52) U.S. Cl. 210/232; 210/443; 210/493.2

(57) ABSTRACT

A replaceable filter element for use with a filter assembly having a housing with a cover and a support core therein. The filter element has a ring of filtration media and an end cap at each end sealingly bonded to the filtration media. The second end cap has a central opening along the central axis of the filter element for receiving the support core. The first end cap also has a central opening along the central axis of the filter element. The central opening of the first end cap has a smaller diameter than the central opening of the second end cap. The central opening of first end cap is bounded by an annular flange integral with the first end cap and projecting axially inward a short distance from the first end cap toward the second end cap and terminating at a point closer to the first end cap than the second end cap. The annular flange is spaced radially inward from the ring of filtration media. A protrusion is located radially between the annular flange and the ring of filtration media, The protrusion is affixed to said first end cap and projects axially inward from the first end cap a short distance toward the second end cap, and remaining with the filter element when the filter element is removed from the housing. The first end cap includes a second annular flange radially outward from the protrusion for engaging with the support core. The second annular flange includes tapered gussets for properly orienting the end cap and the protrusion thereon for reliable interaction with the extension and locking mechanism in the support core when the filter element is assembled in the housing.

### FIELD OF THE INVENTION

This invention pertains to a replaceable filter element for use in a filter assembly that has structure for preventing the operation of the filter assembly without a proper replaceable filter element.

### BACKGROUND OF THE INVENTION

There is disclosed in U.S. Pat. No. 6,554,139 a filter assembly that prevents an improper filter element from being used in the filter assembly and prevents operation of the filter assembly without a filter element in place. The filter assembly includes a replaceable filter element with a ring of filter media and an end cap sealingly bonded to both ends of the filter media. An internal support core is fixed to an end wall of the filter housing, and one of the end caps of the filter element includes a central opening.

The filter element can be removably received over the support core. The support core provides internal support for the filter element.

An extension and locking assembly is provided with the support core. The extension and locking assembly operates to prevent the cover of the housing from being attached to the housing body without a proper filter element installed in the housing or without filter element in the housing. The extension and locking assembly includes bypass member and a locking member. The bypass member is closely and slideably received in the locking member, while the locking member is closely and slideably received in the support core.

When the locking member and the bypass member are in their outer position, the distal inner end of the locking member urges the distal inner end of the bypass member radially outward against the inner surface of the support core. The support core includes an annular step or shoulder along its inner surface, and the distal inner end of the bypass member engages the step to prevent the extension and locking member from being pushed inwardly into the support core. The extension and locking assembly is long enough that the cover of the housing cannot be attached to the housing body when the extension and locking assembly is in its outer position.

The enlarged head of the bypass member includes a series of openings which allow access to the enlarged head of the locking member. The end cap opposite the end cap of the filter element with the central opening has a series of four protrusions that extend axially inward from the end cap, in orientation with the openings in the bypass member. When the filter element is installed over the support core, the protrusions extend through the openings in the head of the bypass member and engage the head of the locking member. The protrusions force the locking member axially inward and move the distal inner end of the locking member away from the distal inner end of the bypass member. This allows the distal inner end of the bypass member to disengage from the step in the support core, and the locking member and bypass member to slide inwardly (retract) into the support core. In its inner position, the extension and locking assembly allows the filter element to be properly located in the filter housing, and the cover to be attached to the housing body. A filter element without a correct arrangement of protrusions on its end cap will not engage the head of the locking member, and the extension and locking assembly will remain locking in its outer position, thereby preventing the filter element from being properly assembled in the filter housing.

The U.S. Pat. No. 6,554,139 shows in the drawing four protrusions generally evenly spaced in an annular arrangement. In the description there is a suggestion that only one protrusion may be necessary in some applications, however, there is no showing in the drawing of a single protrusion and no specific teaching of the orientation and size of the single protrusion. Removing three protrusions from an end cap of the marketed device comparable to that shown in the drawing of the U.S. Pat. No. 6,554,139 would not produce a commercially feasible structure that would operate as intended. It would be expected that the use of a single protrusion would cause imbalance problems and would be impractical.

The present invention is concerned with a replaceable filter element having an end cap with a single protrusion that is constructed and arranged to function reliably in place of the filter element as shown in the U.S. Pat. No. 6,554,139 and to be used in place of the commercial filter element having four protrusion sold by the assignee of the U.S. Pat. No. 6,554,139.

An object of the present invention is to provide a replaceable filter element with an end cap having a single protrusion that is precisely sized and located so as to reliably activate the head of the locking member to force the locking member axially inward and allow the bypass member to disengage from the step in the support core to allow a filter element to be properly located in the filter housing and the cover to be attached to the housing body.

Another object of the present invention is to provide a replaceable filter element with an end cap having an annular flange for cooperating and receiving the outer diameter of the support core so as to more accurately align the filter element and the support core to assure engagement of the single protrusion with the locking member to actuate same.

A further object of the present invention is to provide a replaceable filter element with an end cap having an annular flange with tapered gussets for cooperating with the outer diameter of the support core so as to more accurately align the filter element and the support core to assure engagement of the single protrusion with the locking member to actuate same.

Other objects and advantages of the present invention will be made more apparent hereinafter.

### BRIEF DESCRIPTION OF THE DRAWING

There is shown in the attached drawing a presently preferred embodiment of the present invention, wherein like numerals in the various views refer to like elements and wherein:

FIG. 1 is an exploded perspective view of a prior art filter assembly, illustrating a replaceable filter element below the cover and prior to positioning over the support core;

FIG. 2 is an elevated perspective view of the extension and locking assembly for the filter assembly of FIG. 1;

FIG. 3 is an inside view of the upper end cap for the filter element of FIG. 1;

FIG. 4 is a perspective view of a filter housing, with the cover removed, illustrating an end cap of the replaceable filter element of the present invention in inverted position over the support core, with the filter media omitted for purposes of explanation;

FIG. 5 is a vertical cross section view of the replaceable filter element of the present invention;

FIG. 6 is an enlarged cross section of the end cap of the present invention having a single protrusion and including an annular flange for engaging the outside diameter of the support core;

FIG. 7 is a detail cross section view of the end cap of the present invention, better showing the height and configuration of the protrusion extending from the end cap; and

FIG. 8 is a detail cross section view of the end cap of the present invention, better showing the width and configuration of the protrusion extending from the end cap.

### DETAILED DESCRIPTION OF THE PRESENT INVENTION

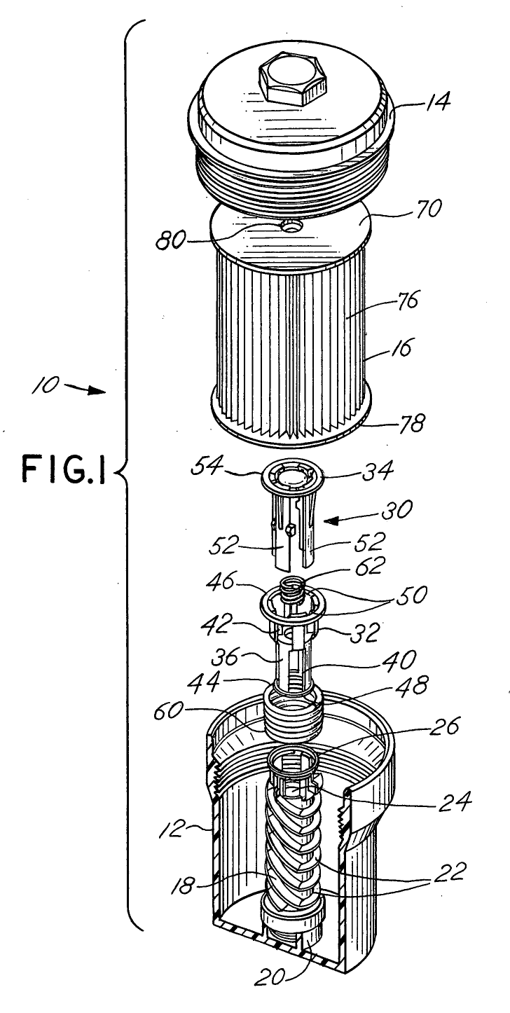

The replaceable filter element of the present invention is intended to interchange with and/or replace the filter element in the filter assembly shown in FIG. 1, which is FIG. 3 from the U.S. Pat. No. 6,554,139. The filter assembly 10 is adapted for filtering water and other particulate and contaminants from fuel, for example, diesel fuel, and can be used for separating any low density fuel, for example, water, from a higher density fluid, for example, oil.

The filter assembly 10 includes an annular housing body 12 with a cup shaped cover 14 removably attached by a threaded connection to the open end of the housing body 12. The housing body 12 and the cover 14 define a cavity for receiving the replaceable filter element 16. Housing body 12 and cover 14 are formed from materials appropriate for the particular application, for example, hard plastic, and the housing body 12 is adapted to be fixed to an appropriate location on the engine.

A support core or tube 18 extends along the axial center line of the housing body 12 and is secured in the spud 20. The support core 18 includes a series of ribs or flights as at 22 along its length. Flights 22 preferably extend in a continuous helix, and facilitate movement of fuel along the length of the support core 18, as well as provide support along the inside surface of the filter element 16. The support core 18 preferably has one or more openings 24 toward its upper end 26 to allow fuel to pass inward into the support core 18. Support core 18 can be formed of material, for example, hard plastic, appropriate for the particular application.

An extension and locking assembly 30 is received on support core 18. The extension and locking assembly 30 prevents the cover 14 from being attached to the housing body 12 unless a proper filter element 16 is installed in the housing. The extension and locking assembly 30 includes a locking member 32 and a bypass member 34, with locking member 32 being closely and slidingly received in bypass member 34, and bypass member 34 being closely and slidingly received in support core 18. Locking member 32 includes a body 36 with a series of lower openings 40 for fluid flow, a series of upper openings 42, an annular base 44, and an enlarged annular head 46. The annular base 44 of the locking member includes a radially-outward projecting annular member 48. Body 36 includes a series of inner axial channels or slots 50, which are positioned to receive fingers 52 of bypass member 34. Locking member 32 is form unitarily from appropriate material, for example, hard plastic.

Bypass member 34 includes fingers 52 and an enlarged head 54 which overlays the enlarged annular head 46 of locking member 32 when fingers 52 are received in channels 50. Fingers 52 extend along slots 50 in locking member 32, and project outwardly (downwardly in FIG. 1) through upper openings 42. An imperforate dome-shaped end wall (not shown) is provided radially inwardly of head 54. Bypass member 34 is preferably formed unitarily (in one piece) from appropriate material, such as, hard plastic.

A main spring 60 is provided in surrounding relation to the outer (upper end) of support core 18 and the locking member 32 and the bypass member 34. Spring 60 extends between an annular shoulder on the support core 18 and the enlarged head 46 of locking member 32. Spring 60 urges the head of the locking member 32 against the head of the bypass member 34, and hence urges these components axially outward from the support core 18. When the bypass member 34 is received in locking member 32, fingers 52 of bypass member 34 project axially through openings 42 in locking member 32 and are received between the annular base 44 of the locking member 32 and the inside surface of the support core 18. The annular flange 48 of the base 44 urges the fingers 52 radially outward against the inner surface of the support core 18, and creates in interference fit to retain the locking member 32 and the bypass member 34 in the support core 18 so as to prevent the main spring 60 from pushing these components entirely outwardly from the support core 18. A bypass spring 62 is provided for biasing the bypass member outwardly away from the locking member 32. Bypass spring 62 extends between the dome-shaped end wall (not shown in FIG. 1) and a radially inward directed spring stop on the locking member 32.

The extension and locking assembly prevents attachment of the cover 14 to the housing body 12 without a proper filter element 16 installed in the housing 12.

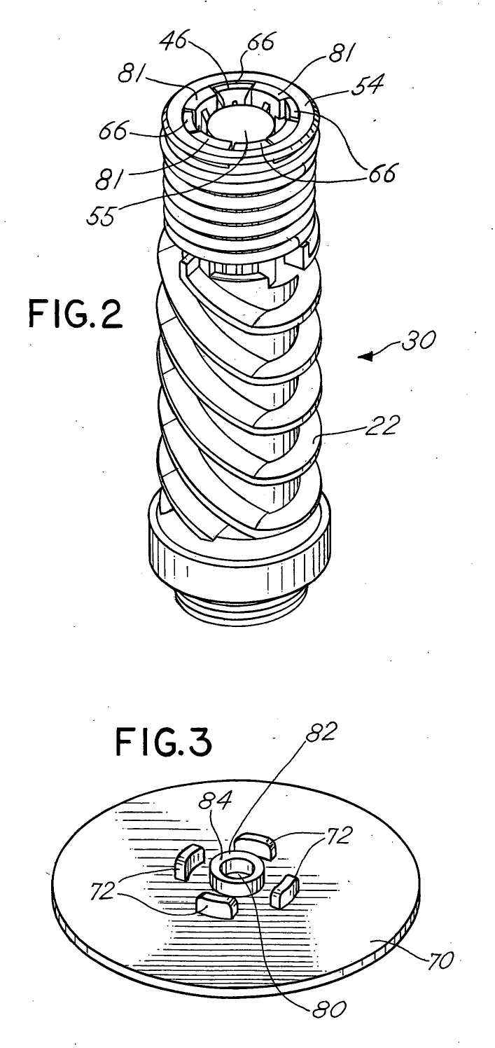

To disengage the bypass member 34 from the step in the support core 18, the base 44 of the locking member 32 is moved axially away from the distal ends of the fingers 52 of the bypass member 34. As shown in FIG. 2, the head 54 of the bypass member 34 has a series of openings 66 that allow access to the underlying head 46 of the locking member 32. The filter element 16 has an end cap 70, which has four distinct, axially projecting protrusions 72 corresponding to the location of the openings 66 in the bypass valve head 54. The four protrusions 72 are shown in a generally evenly spaced annular arrangement extending outwardly, away from the end cap 70. The distal ends of the protrusions 72 and/or the lands 81 between the openings 66 can have angled or ramped surfaces to facilitate the orientation of the protrusions with the openings 66.

When the filter element is installed in the housing, the protrusions 72 on the end cap 70 project through the openings 66 and engage the head 46 of the locking member 32. The protrusions 72 force the locking member 32 axially inward into the support core. The base 44 of the locking member 32 moves axially away from the inner ends of the inner ends of fingers 52 of bypass member 34, thereby allowing the fingers 52 to disengage from the step 48 and the bypass member 34 to slide inwardly into the support core 18. This allows the extension and locking assembly 30 to retract in the support core 18, compressing the main spring 60, and allows the cover 14 to be attached to the housing body 12.

The filter element 16 includes a ring or annulus of filter media 76 formed of an appropriate material. The filter element 16 also includes a disk-shaped end cap 70 sealingly bonded to the outer (upper end) of the filter media 76 and an opposed end cap 78 sealingly bonded to the inner (lower) annular end of the filter media 76. The end cap 78 includes a central circular opening dimensioned to receive the support core 18 and enable the filter element 16 to be removably located over the support core 18.

The outer end cap 70 includes a central opening 80, with a diameter somewhat smaller than the diameter of the central opening in the end cap 78. As seen in FIG. 3, the annular flange 82 bounds the opening 80 in the end cap 70 and projects a short distance axially inward into the filter element 16 from end cap 70 toward end cap 78. The protrusions 72 are spaced radially inward from the ring of filter media 76 and radially outward from the flange 82 The flange 82 includes a tapered distal end 84 which is dimensioned to engage flush against the dome-shaped end wall of the bypass member 34 when the filter element 16 is located in the housing 12. The end caps 70 and 78 are each suitably formed of an appropriate material, such as, plastic.

The foregoing description is applicable to the filter assembly disclosed in the U.S. Pat. No. 6,554,139 and the commercial device made in accordance therewith.

When considering development of an interchangeable filter element for use with the filter assembly of U.S. Pat. No. 6,554,139 (the '139 patent), problems arose with respect to an end cap having a single protrusion. There was no means suggested in the '139 patent for properly orienting the single protrusion with the openings in the bypass valve head 54. If there were failure of radial orientation, the single projection could lodge to the inside of the lands 81. Applicants determined that the size and location of the single protrusion on the end cap were critical to making a reliable smoothly operating replaceable filter element for use in the filter assembly housing. Further, it was determined that it was essential to properly orient the end cap with protrusion with respect to the top of the support core.

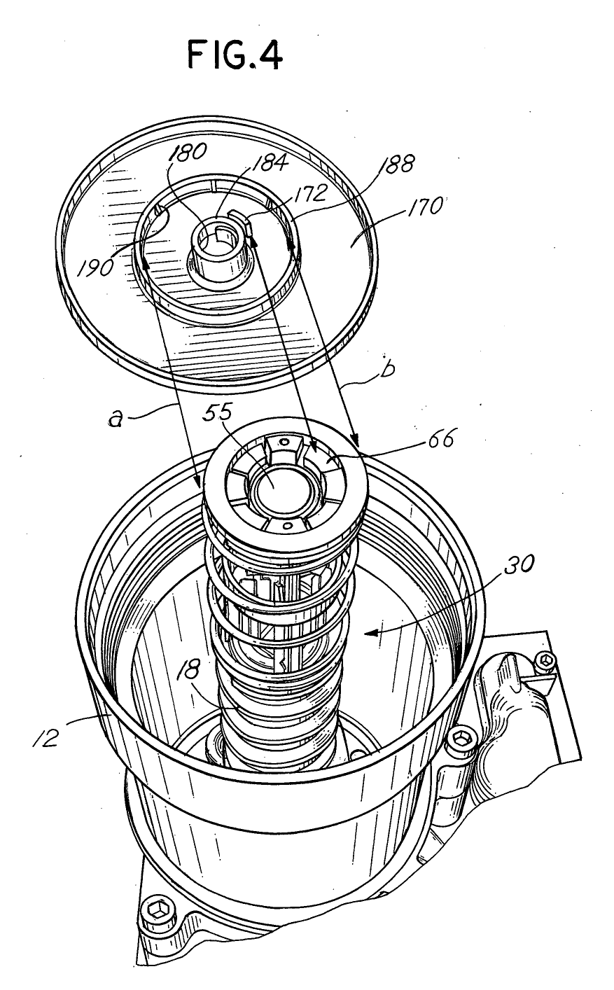

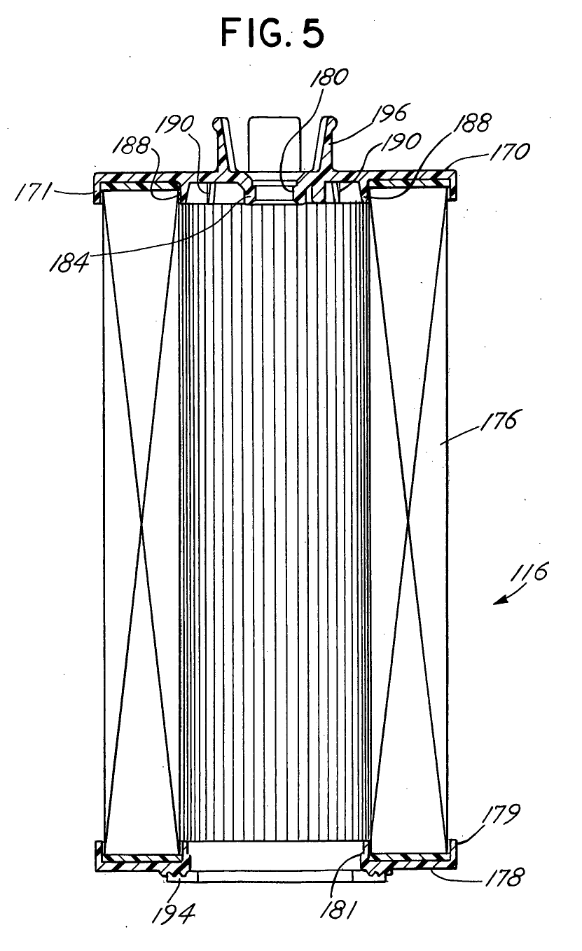

There is shown in FIG. 4 a housing 12 containing a support core 18 with which the replaceable filter element 116 (FIG. 5) can be used. The end cap 170 is shown without the other components of the filter element to provide for ease of explanation and viewing. The end cap 170 is in the form of an annular disk having a central opening bounded by an annular flange 184. Radially outward from the annular flange 184 is a protrusion 172 constructed and arranged so as to reliably cooperate with the support core 18. The proper orientation of the protrusion 172 with the openings—at the top of the support core 18 is assured by means of the annular flange 188, which extends radially outward from the protrusion 172. The annular flange 188 is provided with gussets 190, which are tapered from the outer end of the annular flange 188 to the underside of the end cap 170. Though eight gussets 190 are shown, it will be apparent to persons skilled in the art that other numbers can be utilized to accomplish the objective of properly orienting the end cap 170 and the protrusion 172 thereon with the upper end of the support core 18. The arrows a and b in FIG. 4 indicate how the annular flange 188 will engage in complementary relationship with the head 54 of the support core 18 to align the protrusion 172 with the opening 66 in the top of the support core 18 (see arrow c).

Turning to FIG. 5 there is better seen the filter element 116 of the present invention which includes end caps 170 and 178 sealingly bonded to the ends of the annular filtration or filter media 176. The end caps 170 and 178 are typically molded from plastic and are suitably bonded to the filtration media 176, which may be paper or similar filtration material, by a suitable adhesive. The end caps 170 and 178, respectively, each include an annular flange 171 and 179, respectively, at the outer periphery that at least partially encompasses the filtration media 176. A resilient seal 194 may be affixed to the end cap 194. The upper end cap 170 has a central opening 180 bounded by an annular flange 184 that extends inward or downward from the end cap 170 as viewed in FIG. 5. The annular flange 184 projects or extends a short distance from the end cap 170 toward the end cap 178 and terminates closer to the end cap 170 than the end cap 178. The end cap 178 is provided with a central opening 181 having a diameter larger than the diameter of the central opening 180. The filter element 116 is adapted for filtering oil, however, it can be adapted for other applications.

The upper end cap or the end cap 170 includes upwardly extending fingers 196 for engaging with the cover of the housing (not shown in FIG. 4) to facilitate removal of the replaceable filter element 116 when the cover is removed. Basically, the ends of the fingers 196 will engage in a recess in the cover and when the cover is removed from the housing the replaceable filter 116 will be removed together with the cover.

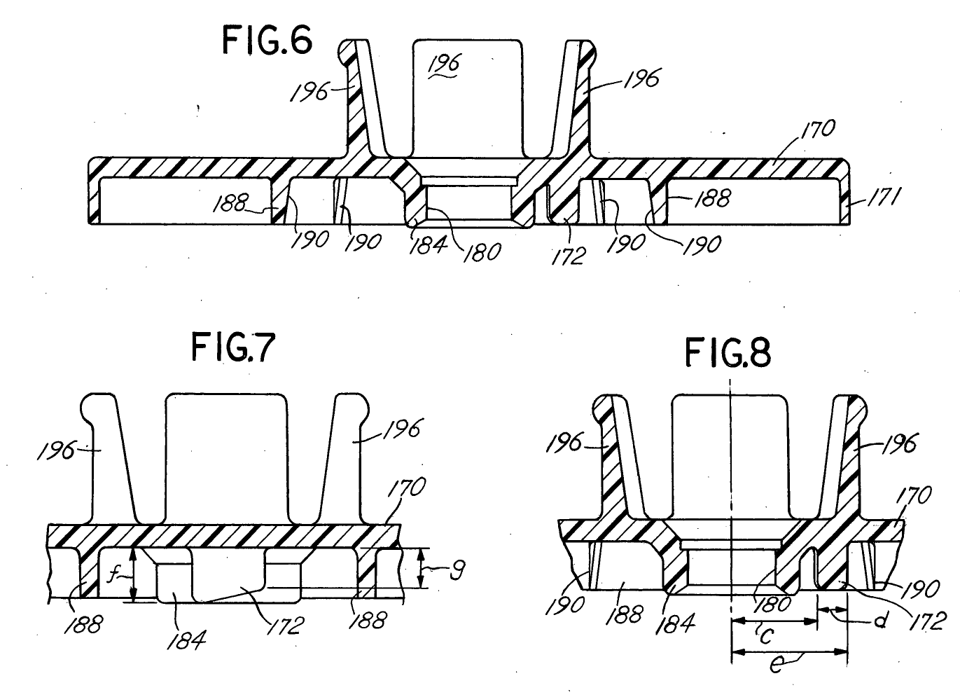

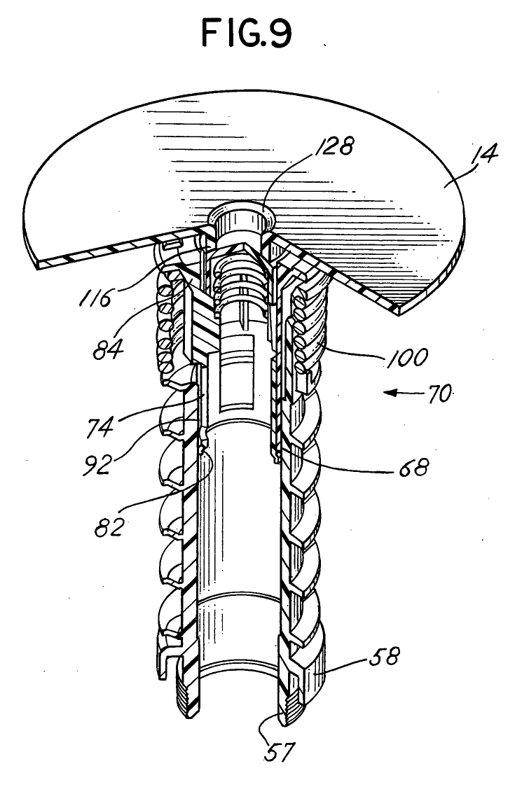

Referring to FIGS. 6, 7, and 8, the details of the end cap 170 are better shown. The gussets 190 are preferably integrally joined with the inner wall of the annular flange 190, which is turn is integrally formed with the end cap 170. Though eight equaly spaced gussets 190 are shown in the drawing, it will be understood that the desired centering effect of the end cap 170 on the support core 18 can be achieved by use of at least three equally spaced gussets 190. A different number of gussets 190 can be used, provided the desired centering is achieved. The fingers 196 extend upwardly from the top of the end cap 170 and are integrally connected to the end cap 170. Preferably, the end cap 170 is formed unitarily by molding. The annular flange 190 is spaced radially outward from the protrusion 172 and extends axially inward from the end cap 170. Preferably the inner diameter of the annular flange 188 is complementary to the outer dimension of the support core which is adapted to be received within the annular flange 188. The annular flange 188 may be continuous as shown in FIG. 4 or it can be discontinuous, provided it provides sufficient support and guidance for the upper end of the support tube 18 when assembled thereon in use.

The gussets 190 are tapered from the outer end of the annular flange 188 toward the lower surface of the end cap 170. When a replaceable filter element 116 is positioned on a support core 18, the tapered gussets 190 help to funnel or guide he support core 18 to a proper, close to center location. This positions the protrusion 172 closer to the central axis of the support core 18 to counteract the imbalance problem presented by use of a single protrusion.

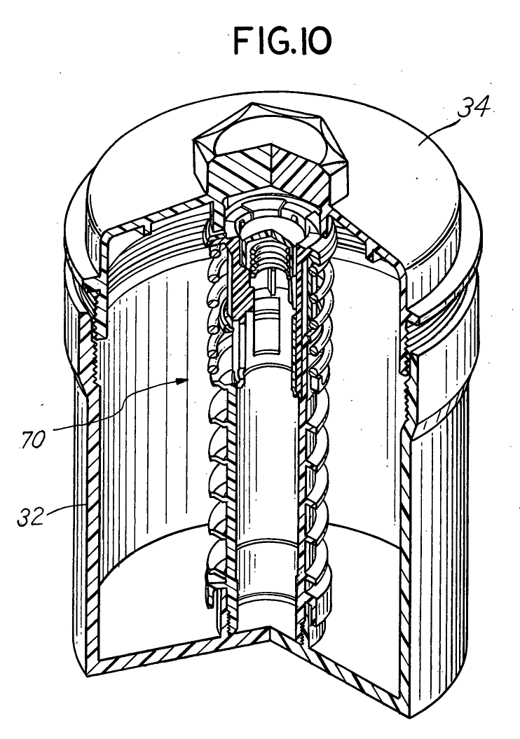

With reference to FIG. 7, there is clearly shown the angled or ramped configuration of the protrusion 172, which helps to locate the protrusion 172 in an opening 66 in the support core 18 (FIG. 4) of the extension and locking assembly 30. In a preferred embodiment the maximum height f of the protrusion is 0.220 inch and the minimum height g is 0.170 inch. With a ratio for f/g of 1.29 a desirable ramping effect is achieved for the protrusion 172.

With reference to FIG. 8, there is more clearly shown the thickness (or width) and the spacing of the protrusion 172 from the central axis of the end cap 170. The inner wall or inner face of the protrusion 172 is offset at a distance c from the center axis of the end cap 170. The outer wall of the protrusion is at a distance e from the center axis of the end cap 170. The thickness or width of the protrusion 172 is denoted by the distance d. In a preferred embodiment the dimension c is 0.468 inch and the dimension e is 0.588. The ratio of e/c is 1.25 helps to provide fool proof operation of the protrusion 172 with respect to the opening 66 in the support core 18 with which it engages. The protrusion 172 is relatively thick and is positioned relatively close to the center axis of the end cap. The thickness of the protrusion 172 was increased since it was no longer necessary for the protrusion 172 to be relatively narrow to take into account the build-up of tolerances associated with using opposed protrusions, as in the '139 patent. With a single protrusion 172, the protrusion 172 can be thicker or wider and still not interfere with any fixed feature of the support core 18. Also, the protrusion 172 acts more directly upon the center line of the extension and locking assembly 30, which helps to further counteract the imbalance problem inherent with one protrusion.

The construction and orientation of the protrusion 172 helps to provide the desired interaction between the protrusion 172 and the opening 66 in the support core 18 with which it is adapted to cooperate. Desired operation is further enhanced when the construction and orientation of the protrusion 172 are coupled with providing the end cap with an annular flange 188 for receiving the top of the support core 18 and guiding the support core 18 within the annular flange 188 by use of the gussets 190.

The invention provides a replaceable filter element with an end cap having a single protrusion for actuating a locking mechanism in the support core, which receives the replaceable filter element. Imbalance resulting from the use of a single protrusion that might impede proper operation of the filter element within the filter assembly is avoided by precisely constructing and orienting the single protrusion on the end cap.

Though the use of a single protrusion on the upper end cap is preferred, it is conceivable that a person skilled in the art might want to adapt the end cap to accept a second oppositely disposed protrusion for certain applications.

While we have disclosed a presently preferred embodiment of the present invention it is understood that the invention may be otherwise embodied within the scope of the following claims.

We claim:

1. A filter element including a ring of filtration media circumscribing a central axis and having first and second ends; a first end cap sealingly bonded to the first end of the filtration media, and a second end cap sealingly bonded to the second end of the filtration media; the second end cap including a central opening along the central axis of the filter element; said first end cap also including a central opening along the central axis of the filter element, said central opening of said first end cap having a smaller diameter than said central opening of said second end cap, said central opening of said first end cap bounded by an annular flange integral with said first end cap and projecting axially inward a short distance from said first end cap toward said second end cap and terminating at a point closer to said first end cap than said second end cap, said annular flange spaced radially inward from the ring of filtration media; at least one protrusion located radially between said flange and said ring of filtration media, said at least one protrusion permanently affixed to said first end cap and projecting axially inward from said first end cap a short distance toward said second end cap.

2. A filter element as in claim 1 wherein the first end cap has a second annular flange spaced radially outward from the protrusion, the second annular flange extending inwardly from the end cap, the inner diameter of the annular flange being complementary to the outer dimension of a member received therein for properly orienting the replaceable filter element in use.

3. A filter element as in claim 2, wherein at least three gussets are provided on the wall of the second annular flange for helping guide the filter element into engaging relationship with a member received therein.

4. A filter element as in claim 3, wherein the gussets are tapered from the end of the second annular flange toward the end cap.

5. A filter element as in claim 2 wherein a plurality of spaced apart gussets are provided on the inner wall of the second annular flange for helping guide the filter element into engaging relationship with a cooperating member received by the second annular flange.

6. A filter element as in claim 1, wherein the thickness of the protrusion is on the order of 0.120.

7. A filter element as in claim 1, wherein the protrusion inner face is offset on the order of 0.468 inch from the central axis.

8. A replaceable filter element for use with a housing having a cover and a support core therein, said filter element including a ring of filtration media circumscribing a central axis and having first and second ends; a first end cap sealingly bonded to the first end of the filtration media, and a second end cap sealingly bonded to the second end of the filtration media; the second end cap including a central opening along the central axis of the filter element for receiving the support core; said first end cap also including a central opening along the central axis of the filter element, said central opening of said first end cap having a smaller diameter than said central opening of said second end cap, said central opening of said first end cap bounded by an annular flange integral with said first end cap and projecting axially inward a short distance from said first end cap toward said second end cap and terminating at a point closer to said first end cap than said second end cap, said annular flange spaced radially inward from the ring of filtration media; at least one protrusion located radially between said flange and said ring of filtration media, said at least one protrusion permanently affixed to said first end cap and projecting axially inward from said first end cap a short distance toward said second end cap, and remaining with the filter element when the filter element is removed from the housing.

9. A filter element as in claim 8, wherein the first end cap has a second annular flange spaced radially outward from the protrusion, the inner diameter of the annular flange being complementary to the outer dimension of the support core for properly orienting the replaceable filter element on the support core in use.

10. A filter element as in claim 9, wherein at least three gussets are provided on the wall of the second annular flange for helping guide the filter element into engaging relationship with a member received therein.

11. A filter element as in claim 10, wherein the gussets are tapered from the end of the second annular flange toward the end cap.

12. A filter element as in claim 9, wherein a plurality of spaced apart gussets are provided on the inner wall of the second annular flange for helping guide the filter element into engaging relationship with a cooperating member received by the second annular flange.

13. A filter element as in claim 9, wherein the thickness of the protrusion is on the order of 0.120.

14. A filter element as in claim 9, wherein the radially inner face of the protrusion is offset on the order of 0.468 inch from the central axis.

15. A replaceable filter element removably positionable within a housing the filter element including a ring of filtration media circumscribing a central axis and having first and second ends; a first end cap sealingly bonded to the first end of the filtration media, and a second end cap sealingly bonded to the second end of the filtration media; the second end cap including a central opening along the central axis of the filter element; said first end cap also including a central opening along the central axis of the filter element, said central opening of said first end cap having a smaller diameter than said central opening of said second end cap, said central opening of said first end cap bounded by an annular flange integral with said first end cap and projecting axially inward a short distance from said first end cap toward said second end cap and terminating at a point closer to said first end cap than said second end cap, said annular flange spaced radially inward from the ring of filtration media; at least one protrusion located radially between said flange and said ring of filtration media, said at least one protrusion permanently affixed to said first end cap and projecting axially inward from said first end cap a short distance toward said second end cap, and remaining with the filter element when the filter element is removed from the housing.

16. A filter element as in claim 15 wherein the first end cap has a second annular flange spaced radially outward from the protrusion, the inner diameter of the annular flange being complementary to the outer dimension of a member received therein for properly orienting the replaceable filter element in use.

17. A filter element as in claim 15, wherein at least three gussets are provided on the wall of the second annular flange for helping guide the filter element into engaging relationship with a cooperating member received therein.

18. A filter element as in claim 17, wherein the gussets are tapered from the end of the second annular flange toward the end cap.

19. A filter element as in claim 16, wherein a plurality of spaced apart gussets are provided on the inner wall of the second annular flange for helping guide the filter element into engaging relationship with a cooperating member received by the second annular flange.

20. A filter element as in claim 15, wherein the thickness of the protrusion is on the order of 0.120 and wherein the radially inner face of the protrusion is offset on the order of 0.468 inch from the central axis of the end cap.
